(19) United States
(12) Patent Application Publication
(10) Pub. No.: US 2015/0111507 A1
(43) Pub. Date: Apr. 23, 2015

(54) MILLIMETER WAVE CONDUCTIVE SETUP

(71) Applicant: QUALCOMM Incorporated, San Diego, CA (US)

(72) Inventor: Reuven ALPERT, Caesarea (IL)

(21) Appl. No.: 14/520,086

(22) Filed: Oct. 21, 2014

Related U.S. Application Data
(60) Provisional application No. 61/893,326, filed on Oct. 21, 2013.

(51) Int. Cl. H04W 24/06; H04B 17/00; H04B 7/24; G05B 15/02

(52) U.S. Cl. CPC H04W 24/06; G05B 15/02; H04B 17/00; H04B 7/24
USPC 455/67.14

(57) ABSTRACT

Aspects of the disclosure provide techniques, apparatuses, and systems for testing communications between devices in a wireless system. According to certain aspects, these techniques may involve utilizing one or more variable attenuators to simulate conditions of one or more wireless channels between devices in the wireless system. According to certain aspects, these techniques may be used to facilitate testing of communications for millimeter wave (mm-wave) (RF) systems (operating within the 60 GHz frequency band).

### CROSS-REFERENCE TO RELATED APPLICATION(S)

This application claims the benefit of U.S. Provisional Application Ser. No. 61/893,326, entitled “MILLIMETER-WAVE CONDUCTIVE SETUP,” filed on Oct. 21, 2013, which is assigned to the assignee of the application and hereby expressly incorporated by reference herein in its entirety.

### BACKGROUND

I. Field

Certain aspects of the disclosure generally relate to techniques and apparatus for testing wireless devices and radio frequency (RF) modules of such devices.

II. Background

The demand for higher bandwidth capability has been driving wireless communications devices with higher frequencies for many years. Frequency bands of devices have risen from megahertz (MHz) to the low gigahertz (GHz). A next step in this progression (e.g., as specified by IEEE 802.11ad), are frequency bands in the range of 57-64 GHz, often referred to as the “60 GHz frequency band.”

The 60 GHz frequency band is an unlicensed band, which features a large amount of bandwidth. The large bandwidth means that a very high volume of information may be transmitted wirelessly. As a result, multiple applications that require transmission of a large amount of data may be developed to allow wireless communication around the 60GHz band. Examples for such applications include, but are not limited to, wireless high definition TV (HDTV), wireless docking stations, wireless Gigabit Ethernet, and many others.

The 60 GHz frequency band presents challenges to RF designers and engineers, such as absorption of signals by rough surfaces that would be transparent to lower frequencies, as well as issues with line-of-sight (LOS) communication of narrow beams that can easily be blocked by objects (including persons) standing in front of a transceiver device. As a result of such difficulties associated with receiving high frequency signals, systems for testing RF modules operating in the 60 GHz frequency band are desirable.

### SUMMARY

Aspects of the disclosure provide a method for testing communications between wireless devices. The method generally includes obtaining test signals provided by at least one first device, altering the test signals to simulate varying conditions of one or more wireless channels between the at least one first device and at least one second device, providing the altered test signals to the at least one second device, and obtaining feedback regarding reception of the altered test signals received at the at least one second device.

Aspects of the disclosure provide an apparatus for testing communications between wireless devices. The apparatus generally includes a first interface for obtaining test signals provided by at least one first device, at least one controller for altering the test signals to simulate varying conditions of one or more wireless channels between the at least one first device and at least one second device, a second interface for providing the altered test signals to the at least one second device, and a third interface configured to provide feedback to the at least one controller regarding reception of the altered test signals received at the at least one second device.

Aspects of the disclosure provide an apparatus for testing communications between wireless devices. The apparatus generally includes a first interface configured to obtain test signals provided by at least one first device, one or more variable attenuators configured to receive the test signals as input and configured to alter the test signals based on control signals, and a second interface configured to provide the altered test signals to at least one second device.

### BRIEF DESCRIPTION OF THE DRAWINGS

Aspects of the disclosure will become more apparent from the following detailed description when taken in conjunction with the drawings in which like reference characters identify correspondingly throughout.

FIG. 1 illustrates an example block diagram of a conductive testing apparatus for devices in a wireless system in accordance with certain aspects of the present disclosure.

FIG. 2 illustrates an example diagram of a horn antenna that may be utilized in a conductive testing apparatus for devices in a wireless system in accordance with certain aspects of the disclosure.

FIG. 3 illustrates an example block diagram of a conductive testing apparatus for wireless devices in accordance with certain aspects of the present disclosure.

FIG. 4 illustrates example operations for testing communications between devices in a wireless system, in accordance with certain aspects of the disclosure.

FIG. 5 illustrates an example setup that may be used for testing devices in a RF system operating in the 60 GHz band, in accordance with certain aspects of the disclosure.

FIG. 6 illustrates an example block diagram of a conductive testing apparatus for wireless devices in accordance with certain aspects of the present disclosure.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein, one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The word “exemplary” is used herein to mean “serving as an example, instance, or illustration.” Any aspect described herein as “exemplary” is not necessarily to be construed as preferred or advantageous over other aspects

Aspects of the disclosure provide techniques, apparatuses, and systems for testing communications between devices in a wireless system. As will be described in greater detail below, these techniques may involve utilizing one or more variable attenuators to simulate conditions of one or more wireless channels between devices in the wireless system.

As will be further described below, these techniques may be used to facilitate testing of communications for millimeter wave (mm-wave) (RF) systems (operating within the 60 GHz frequency band). To help overcome some of the challenges noted above with signals transmitted in high frequency bands, antenna to waveguide adapters may be utilized to conductively channel signals received to the variable attenuators.

The variable attenuators may be controlled to perform a variety of tests. For example, signals may be more heavily attenuated over time to determine data rate versus attenuation, select frequencies may be attenuated to simulate frequency-selective fading, certain signals may be attenuated or amplified to simulate interference, and certain signals may be delayed to simulate multi-path effects.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As noted above, in general, due to the challenges presented by the 60 GHz band, designs for the testing of such RF systems may be desirable. In some cases, a conductive setup for a wireless system, that allows RF signals to be received and conductively coupled to test components, may help with the testing of the system by permitting users to debug and measure the performance of the wireless system in a controlled environment. In some cases, such a conductive setup for millimeter wave (mm-wave) (RF) systems (operating within the 60 GHz frequency band) may present design challenges due to the type of antennas (e.g., a phased array of antennas) typically utilized in such RF systems. For example, in some cases, the phased array of antennas may not be able to directly connect to a cable or waveguide connector in the testing system. As will be described in greater detail below, this issue may be addressed using an antenna to waveguide adapter that utilizes a horn antenna to receive directional (e.g., beam-formed or beam-steered) signals and transfer them to a conductive waveguide.

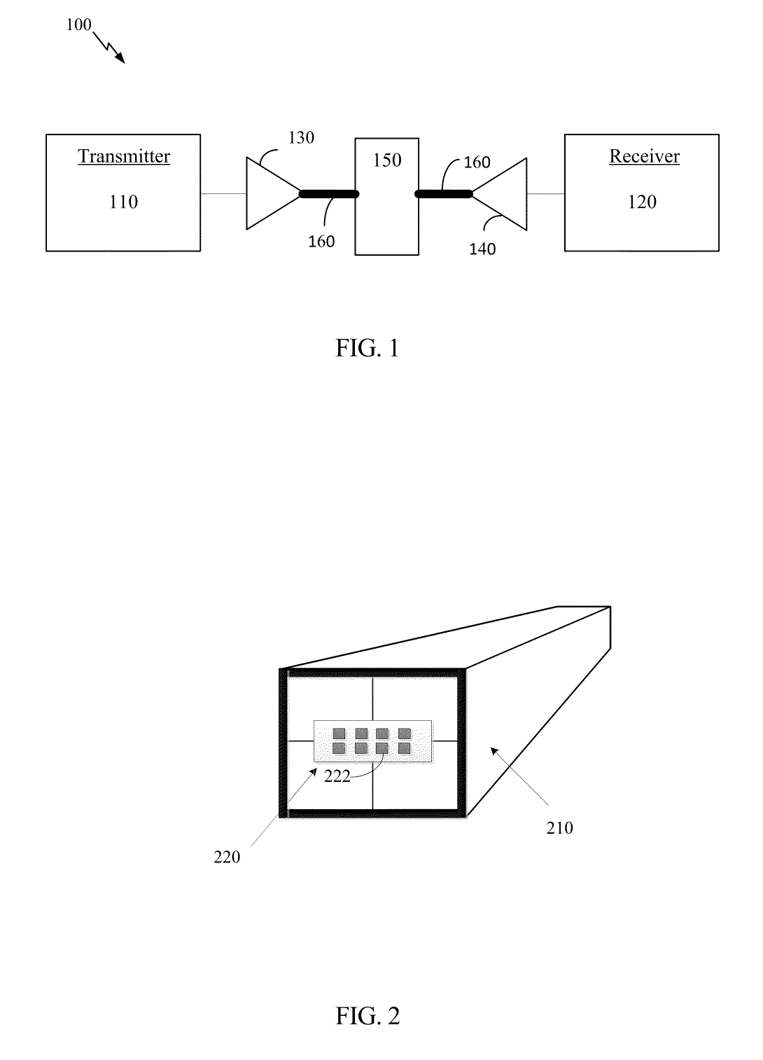

FIG. 1 illustrates a high level block diagram of an example conductive testing apparatus 100 for testing communication between wireless devices, in accordance with aspects of the disclosure. Such a system may be used as a test setup for a millimeter wave (mm-wave) RF system using one or more variable attenuators (although a single attenuator 150 is shown) to simulate conditions of one or more wireless channels between devices in the wireless system.

The conductive testing setup 100 may include a transmitter 110 and a receiver 120 (which may be mm-wave devices), a transmit (TX) antenna 130, a receive (RX) antenna 140, the variable attenuator 150 and antenna-to-waveguide adapters 160 for coupling the TX antenna 130 and RX antenna 140 to the variable attenuator 150. In certain aspects, the transmitter 110 and receiver 120 may be implemented as a mm-wave transceiver (not shown) when configured to perform a specific function (e.g., receive or transmit). The transmitter 110 and receiver 120 under test may be installed in a computer, a testing station, an access point, a mobile device, a wireless docking station, or any other suitable device that is configured to communicate via a wireless or wired medium.

According to certain aspects, the transmitter 110 and the receiver 120 may not include the array of active antennas. For example, an array 220 of active antennas 222 illustrated in FIG. 2 may be formed in a waveguide 210 conductively coupled to the variable attenuator(s) 150. Rather, in some aspects, the array 220 of active antennas 222 may be installed on the respective TX and RX antennas 130 and 140. For example, the array 220 of active antennas 222 of the transmitter 110 may be installed on the TX antenna 130 and the array 220 of the active antennas 222 of the receiver 120 may be installed on the RX antenna 140.

Each of the transmitter 110 and receiver 120 may include an RF circuit (not shown) and a baseband circuit (not shown) that transmit and receive mm-wave signals in the 60 GHz frequency band. When transmitting signals, the baseband circuit typically provides the transmitter 110 with control, local oscillator (LO), intermediate frequency (IF), and power (DC) signals. The control signal(s) may be utilized for functions such as gain control, RX/TX switching, power level control, sensor data, detector readouts, and selecting (active) antennas. The power signals are typically DC voltage signals that power the various components of the RF circuit.

In the transmitter 110, the RF circuit typically performs up-conversion, using a mixer (not shown), to convert the IF signal(s) to RF signals before transmitting the RF signals through the TX antenna 130, based on the control signals. In the receiver 120, the RF circuit receives (mm-wave) RF signals through the RX antenna 140 performs down-conversion, using a mixer, to convert the RF signals to IF signals via the LO signals, and sends the IF signals to the baseband circuit.

The mm-wave variable attenuator 150 may be coupled to the TX antenna 130 and the RX antenna 140 via antenna to waveguide converters 160. In certain aspects, the variable attenuator 150 may be designed (and controlled) to result in signal variation that is roughly equivalent to air channel propagation between the TX antenna 130 and RX antenna 140. For example, as will be described in more detail below, the variable attenuator 150 may simulate varying conditions of one or more wireless channels between the transmitter 110 (via TX antenna 130) and receiver 120 (via TX antenna 140).

In the example system of FIG. 1, only a single transmitter 110 and receiver 120 are shown. However, according to certain aspects, the testing setup 100 may include (not shown) multiple transmitters 110 and/or multiple receivers 120, with multiple variable attenuators to simulate air channel conditions between multiple transmit-receive antenna pairs.

As described above, according to certain aspects presented herein, the array of active antennas 235 of the transmitter 110 may be installed on the TX antenna 130 and the array of the active antennas 235 of the receiver 120 may be installed on the RX antenna 140.

According to certain aspects, an array of active antennas 235 of a horn antenna 230 may be controlled to receive/transmit radio signals in a certain direction, to perform smart antenna operations such as beamforming, directional diversity, polarization diversity, to switch from receive to transmit mode and vice versa (activating, increase antenna weights or amplitudes). For example, in some cases, the active antenna may be a phased array antenna in which each radiating element may be controlled individually to enable the usage of beam-forming techniques.

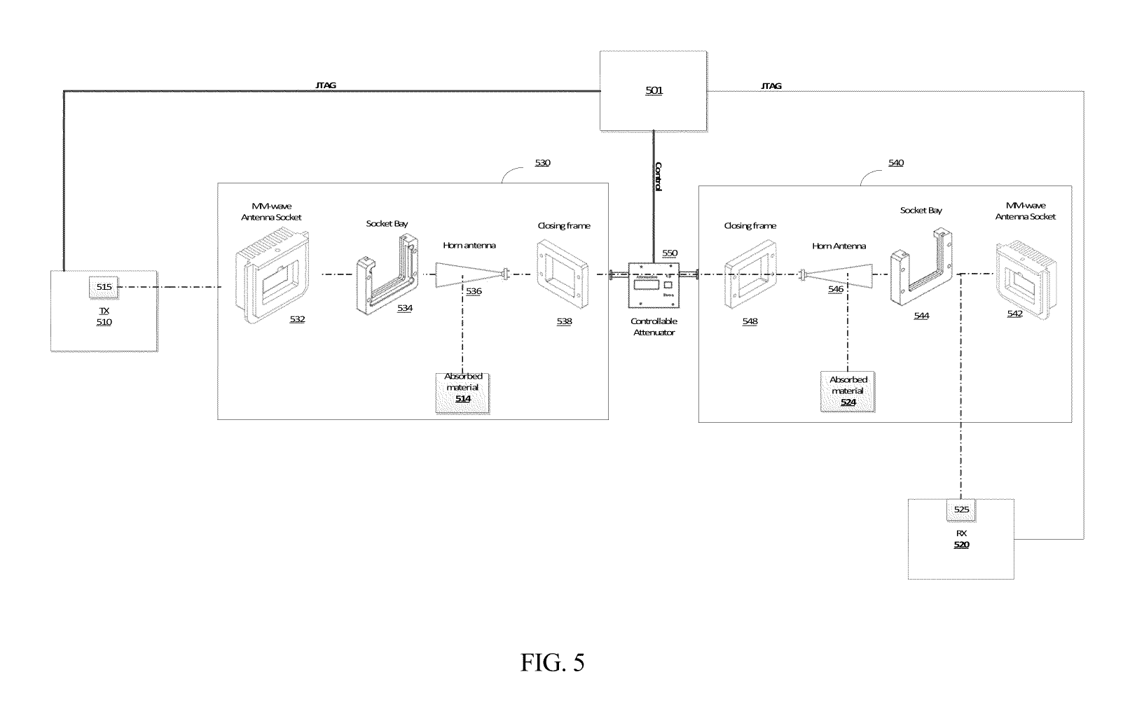

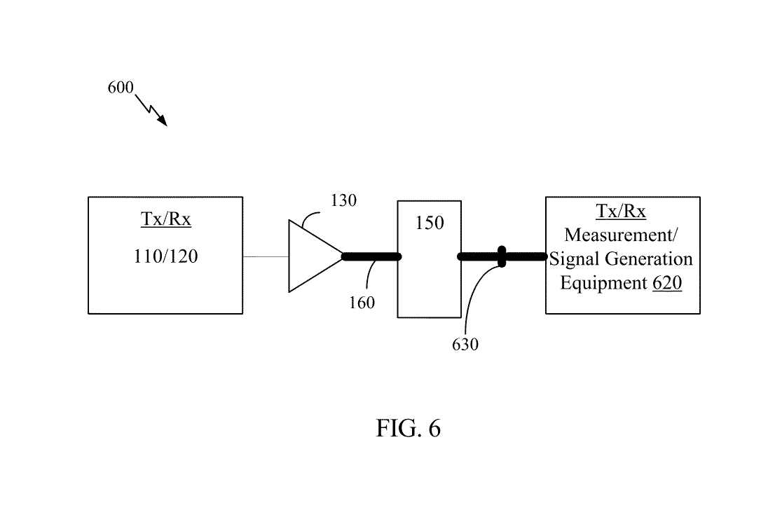

The active antenna(s) 235 may be attached to a metal fixture which is connected to the opening of horn antenna. The metal fixture may center the active antenna(s) 235 in the middle of the opening of horn antenna 230. The fixture may also block the back lobes of horn antenna 230 and prevent them from propagating backward. According to certain aspects, the internal part of the horn antenna 230 may be padded with absorbing material (e.g., absorbing materials 514 and 524 illustrated in FIG. 5) in order to substantially eliminate the effects of parasitic waveguide working wave modes that generally result from the antenna-to-waveguide connection associated with horn antenna 230.

The array of active antennas 235 may be connected with a cable (not shown), or any suitable type of waveguide, to the transmitter 110 and the receiver 120. The RX antenna 140 may be structured in a similar way to the horn antenna 230. The array of active antennas 235 may be any type of active antennas including, but not limited to, a phased array of antennas.

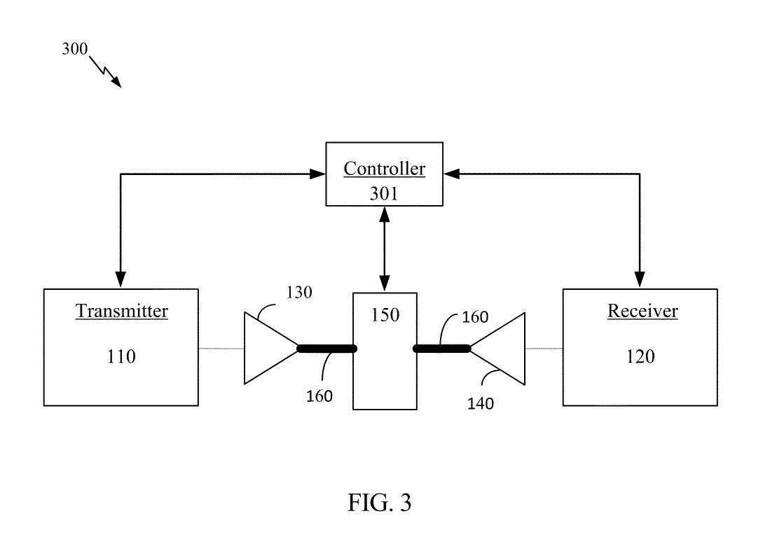

As illustrated in FIG. 3, a test setup 300 may also include a controller 301. During a test procedure, the controller 301 may communicate with transmitter 110 to initiate the sending of test signals, control the variable attenuator 150 to simulate certain channel conditions, and may receive feedback from receiver 120, regarding the test signals as received. Controller 301 may record this feedback and may the test signals being transmitted from transmitter 110 and/or may vary control of the variable attenuators 150 to simulate certain channel conditions. While shown as a separate component, according to some aspects, controller 301 may be integrated with other devices in the test setup 300, such as the variable attenuator(s) 150.

In general, as the signal(s) propagates through the wireless channel(s), the signal(s) may be affected by different phenomena such as reflection, refraction, diffraction, absorption, polarization, scattering, multipath, etc. In some cases, each of the phenomena may have an effect on the power of the signal(s) transmitted by transmitter(s) 110 via TX antenna(s) 130. Generally, if the power of the signal(s) transmitted is higher than the noise level generated in the receiver(s) 120, the signal may be detected and received correctly.

The signal-to-noise ratio (SNR) may be determined by the distance between the transmitter 110 and receiver 120. The noise level in the receiver 120 at steady temperature may be constant. The signal level in a line of sight (LOS) environment may be determined by the distance between the transmitter 110 and the receiver 120. In general, doubling the distance between the transmitter 110 and the receiver 120 may reduce the signal level by 6 dB.

In general, to test the sensitivity of the RF system, the distance between the transmitter 110 and receiver 120 is increased until the receiver 120 is unable to properly receive the signal(s). However, as noted above, this technique may not be ideal for testing of RF systems in a controlled (lab) environment. For example, in some cases, the range necessary to properly test the reception of the signal(s) may extend to thousands of meters. While impractical to test at these actual distances, the variable attenuators allow for simulation of a wireless channel over such distance.

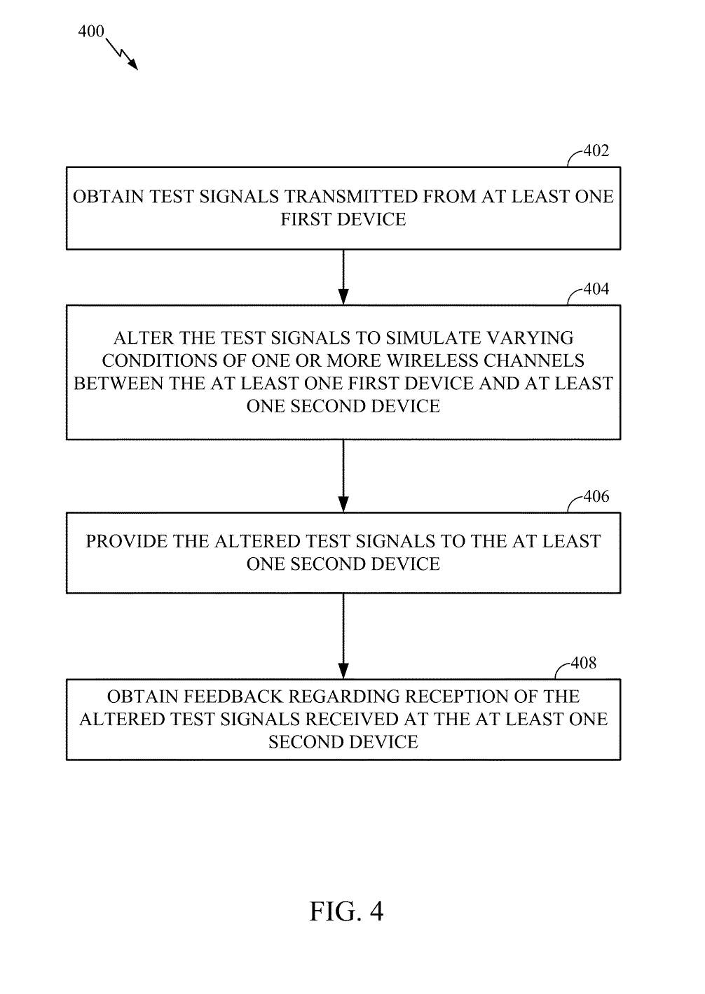

In other words, the test setups presented herein (e.g., as illustrated in FIGS. 1, 3 and 5) may facilitate the testing of RF systems by replacing the wireless channel(s) with one or more waveguide-based variable attenuators 150 under control of controller 301. The variable attenuator(s) 150 may be conductively coupled to TX antenna(s) 130 and the RX antenna(s) 140 via antenna to waveguide converters/adapters 160. The controller 301 may be configured to perform operations described below, for example, with reference to FIG. 4.

As shown in FIG. 3, the controller 301 may be communicatively coupled to the transmitter(s) 110, receiver(s) 120 and attenuator(s) 150. In an aspect, although only one controller 301 is illustrated in FIG. 3, the conductive testing apparatus 300 may include more than one controller 301. The controller(s) 301 may be configured to communicate bi-directionally with transmitter(s) 110, receiver(s) 120 and attenuator(s) 150. In one aspect, the controller(s) 301 may communicate with the variable attenuator(s) 150, the transmitter(s) 110 and the receiver(s) 120 via a wired or wireless interface. For example, in one implementation, the controller(s) may communicate with the attenuator(s) 150, the transmitter(s) 110 and the receiver(s) 120 via a wired interface such as USB, Ethernet, PCI, etc. In another implementation, the controller(s) 301 may communicate with the variable attenuator(s) 150, the transmitter(s) 110 and the receiver(s) 120 via a wireless interface such as Bluetooth, WIFI, etc. In yet another implementation, the controller 301 may communicate with the variable attenuator(s) 350, the transmitter(s) 110 and the receiver(s) 120 via a combination of wired and/or wireless interfaces. For example, the controller 301 may communicate with the attenuator(s) 350 via USB and communicate with the transmitter(s) 110 and receiver(s) 120 via WIFI.

According to certain aspects of the disclosure, the wireless channel (simulated by the variable antennas in FIGS. 1, 3 and 5) may be described by the following equation:

y(t)=x(t)*h(t)+n(t)

where x(t) is the transmitted signal, h(t) is the conjugate transpose of the channel matrix h(t) which represents the wireless channel as a function of time between the transmitter 110 and receiver 120, n(t) is the noise over time and y(t) is the received signal. In an aspect, n(t) may be additive white Gaussian noise (AWGN). According to an aspect, the variable attenuator(s) 150 may simulate the channel matrix h(t) to reflect varying conditions of the channel(s) over time.

According to certain aspects, by utilizing the variable attenuator h(t)~ the conductive testing setups shown in FIGS. 1, 3 and 5 may be used to perform various communication tests between transmitter(s) 110 and receiver(s) 120. For example, in one aspect, the conductive testing apparatus may be used simulate the range of the wireless channel(s) between the transmitter(s) 110 and receiver(s) 120. In some cases, the conductive testing apparatus 100 may be used to simulate a direct line of sight (LOS) path between the transmitter(s) 110 and receiver(s) 120. In other cases, the conductive testing setup 300 may simulate a path affected by one or more phenomena such as reflection, refraction, scattering, etc. In general, however, according to aspects presented herein, the conductive testing apparatus 300 may facilitate the testing of any natural and/or artificial phenomena that may affect the transmission of signal(s) transmitted from transmitter(s) 110 to receiver(s) 120.

FIG. 4 illustrates example operations 400 for testing communications between devices in a wireless system. The operations 400 may be performed, for example, by controller 301 in FIG. 3 or controller 501 in FIG. 5, in conjunction with other components of the test setups shown therein.

The operations 400 begin, at 402, by obtaining test signals transmitted from at least one first device. At 404, the controller alters the test signals to simulate varying conditions of one or more wireless channels between the at least one first device and at least one second device. At 406, the altered test signals are provided to the at least one second device. At 408, feedback is obtained regarding reception of the altered test signals received at the at least one second device.

As mentioned above, according to certain aspects, due to the challenges presented by the 60 GHz band, there may be a need for a system that facilitates the testing of RF systems (operating in the 60 GHz band). FIG. 5 illustrates an example mm-wave conductive testing apparatus 500 for devices in a RF system (operating in the 60 GHz band), in accordance with certain aspects of the disclosure. In certain aspects, the conductive testing apparatus 500 may be the conductive testing apparatus 100 in FIG. 1, or the test setup of FIG. 3.

FIG. 5 illustrates greater detail for an example test setup 500, in accordance with certain aspects of the disclosure. As shown in FIG. 5, the test setup 500 may include transmitter(s) 510, receiver(s) 520, TX antenna(s) 530, RX antenna(s) 540, controller(s) 501 and controllable attenuator(s) 550. The transmitter(s) 510 and receiver(s) 520 may include one or more processors 515 and 525, respectively, for use in processing signals. The processors 515 and 525 may be configured to access instructions stored in memory (not shown) to transmit and/or receive signals for use in the conductive testing apparatus 500.

As mentioned above, the transmitter(s) 510 and receiver(s) 520 may communicate with controller(s) 501 via either a wired or wireless interface. In an aspect, the controller(s) 501 (via the wired or wireless interface) may control transmitter(s) 510 to transmit signals via TX antenna(s) 530 and may control receiver(s) 520 to receive signals via RX antenna(s) 540. As also mentioned above, the controller(s) 501 may also control controllable attenuator(s) 550 via either a wired or wireless interface. The controller(s) 501 may include an intelligent hardware device, e.g., a central processing unit (CPU), a microcontroller, an application specific integrated circuit (ASIC), etc. The controller(s) 501 may also be configured to access instructions stored in memory (not shown) to implement methods such as those described herein.

The transmit antenna(s) 530 may include an antenna socket 532, a socket bay 534, a horn antenna 536 and a closing frame 538. The antenna socket 532 (e.g., to accept insertion and removal of an antenna array) may be inserted into the socket bay 534 and the horn antenna 536 may be enclosed in the closing frame 538. The antenna socket 532 may, thus, provide a structure to hold the array of transmit antennas (e.g., array of active antennas 235 in FIG. 2). In an aspect, the horn antenna 536 may be the horn antenna 230 illustrated in FIG. 2. The horn antenna 536 may contain absorbing material 514.

The receive antenna 540 may include a mm-wave antenna socket 542, a socket bay 544, a horn antenna 546 and a closing frame 548. The mm-wave antenna socket 542 may be inserted into the socket bay 544 and the horn antenna 546 may be enclosed in the closing frame 548. In an aspect, the antenna socket 542 may provide a structure to hold the array of receive mm-wave antennas (e.g., array of active antennas 235 in FIG. 2). In an aspect, the horn antenna 546 may contain absorbing material 524. As noted above, the absorbing materials 514 and 524 may be utilized to substantially eliminate the effects of the parasitic waveguide created due to the connection of the horn antenna to the waveguide connection. In another aspect, each of the horn antennas 536 and 546 may have a nominal gain of 15-25 db.

According to certain aspects (e.g., as described above with reference to FIG. 4), the conductive testing apparatus 500 may facilitate the testing of communications between wireless devices in a RF system over a wide variety of varying simulated channel conditions. For example, the controller(s) 501 may direct the transmitter(s) 510 to transmit the one or more test signals (e.g., via communications transmitted through a Joint Test Action Group (JTAG) interface between the controller 501 and the transmitter(s) 510.) Once transmitted, the propagation of the one or more test signals through the wireless channel(s) between the transmitter(s) 510 and receiver(s) 520 may be simulated by one or more variable attenuators 550. In certain aspects, the controller(s) 501 may control the one or more variable attenuators 550 to alter the test signals to simulate varying conditions of one or more wireless channels between the transmitter(s) 510 and receiver(s) 520.

For example, in one aspect, the controller(s) 501 may control one or more variable attenuators 550 to vary attenuation of at least some frequencies of the test signals to simulate varying distances between the transmitter(s) 510 and the receiver(s) 520. In another aspect, the controller(s) 501 may control the one or more variable attenuators to vary attenuation of certain frequencies of the test signals to simulate frequency selective fading.

According to certain aspects, the conductive testing apparatus 500 may be utilized to simulate effects of multipath (e.g., by delaying and applying different levels of attenuation to the same signal) and/or interference on test signals transmitted between devices in a wireless system. In this case, the one or more variable attenuators 550 may include a plurality of attenuators 550. The controller(s) 501 may then control the plurality of attenuators 550 to simulate interference and/or multipath effects of transmissions between transmitter(s) 510 and receiver(s) 520. In an aspect, the controller(s) 501 may control the plurality of attenuators 550 to delay one or more of the test signals routed through at least one of the variable attenuators 550 to simulate multipath effects of transmissions between the transmitter(s) 510 and receiver(s) 520. For example, the delaying of the one or more test signals routed through at least one of the variable attenuators 550 may simulate one or more additional signals generated due to reflection, refraction, or scattering, as might happen in real world conditions.

In an aspect, the controller(s) 501 may control the plurality of attenuators 550 to simulate interference caused by transmissions from different entities in the wireless system. In another aspect, the controller(s) 501 may control the plurality of attenuators 550 to simulate interference caused by multiple input multiple output (MIMO) channels on which the test signals are transmitted. In general, however, the controller(s) 501 may control the plurality of attenuators 550 to simulate interference caused by any source (natural or artificial) that affects the transmission and/or reception of the test signals.

In addition to controlling the one or more attenuators, the controller(s) 501 may also control the transmitter(s) 510 and/or receiver(s) 520 to perform various tests. In one aspect, for example, the controller(s) 501 may test various beamforming scenarios by controlling the array of transmit antennas at the transmitter(s) 510 and/or the array of receive antennas at the receiver(s) 520. For example, controller(s) 501 may selectively activate receive antennas and/or transmit antennas (e.g., by varying corresponding antenna weights in a beamforming matrix).

As shown in FIG. 5, after controlling the one or more attenuators 550 to alter the test signals, the altered test signals may be received by the receiver(s) 520 via receive antenna(s) 540. In certain aspects, the controller(s) 501 may direct the transmission of the altered signals to the receiver(s) 520 via one or more antennas. The controller(s) 501 may then obtain feedback regarding the altered test signals, as received at the receiver(s) 520. For example, the controller(s) 501 may receive the feedback from the receiver(s) 520 via communications transmitted through a JTAG interface between the controller(s) 501 and the receiver(s) 520. In certain aspects, the feedback obtained from receiver(s) 520 may include information such as data rate, attenuation (e.g., signal strength) of the test signals, or SNR. Based on the feedback, the controller(s) 501 may record the data rate as a function of the attenuation for the test signals.

It should be noted that although FIG. 5 illustrates the controller(s) 501 communicating with the transmitter(s) 510 and receiver(s) 520 via a JTAG interface, as mentioned above, the controller(s) 501 may communicate with the transmitter(s) 510 and receiver(s) 520 via any wired, wireless, or combination of wired and wireless interface. Further, the controller(s) 501 may also control the one or more attenuators 550 via any wired, wireless, or combination of wired and wireless interface.

FIG. 6 illustrates another example test setup 600. In this example, rather than a second device (e.g., 120 as shown in FIG. 1) receiving the test signals, lab equipment may be used to measure received test signals (or this lab equipment may be considered the second device). As an example, the lab equipment may be standard lab equipment used to measure millimeter wave signals and may be connected with a waveguide connector 630 to the variable attenuator(s) 150. As illustrated, in this setup, there may be no need for a horn antenna adaptor-as the altered signals from the variable attenuator may be supplied directly to the measurement equipment 620.

The equipment 620 connected could be a receiver or a transmitter. Examples of receiving equipment may include a spectrum analyzer, power meter or down converter with a sampling scope. Examples of transmitting equipment may include a signal generator or waveform generator (and the transmitted signals may be altered by the variable attenuator(s) 150 and the altered signals received by a receiver device 120. This example test setup shown in FIG. 6 may be useful for basic RF measurements for testing RF components in a transmitter 110 and/or receiver 120.

As described herein, the use of conductive test setups (e.g., illustrated in FIGS. 1, 3, 5 and 6) may help overcome the challenges associated with the testing of communications between devices (operating in the 60 GHz band) in a wireless system. In certain aspects, the conductive testing apparatuses disclosed herein may be used to run low-level tests (e.g., such as sending a tone, ping tests, trace routes, etc.), data vs. attenuation tests, high-throughput tests, beamforming tests, and MIMO simulations.

In general, however, the conductive testing apparatuses disclosed herein may allow for any type of test of the communications between devices in a wireless system. In another aspect, the conductive testing apparatuses disclosed herein may facilitate the simulation of different scenarios that may affect communications between wireless devices in a RF system. For example, the conductive testing apparatuses may be used to simulate LOS scenarios, multipath scenarios and/or interference scenarios (e.g., due to multiple transmitters and/or receivers in the wireless system), and other types of scenarios.

As used herein, a phrase referring to “at least one of” a list of items refers to any combination of those items, including single members. As an example, “at least one of: a, b, or c” is intended to cover: a, b, c, a-b, a-c, b-c, and a-b-c, or any such combination with multiples of a, b, and/or c.

The aspects disclosed are only examples intended to illustrate the many possible advantageous uses and implementations of the innovative teachings presented herein. In general, statements made in the specification of the application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

The various illustrative logical blocks, modules and circuits described in connection with the disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the receiving test signals, transmitting test signals, controlling one or more variable attenuators to alter test signals to simulate varying conditions of one or more wireless channels, obtaining feedback, recording feedback and other operations performed by the modules illustrated in FIGS. 1, 3 and 5 may be performed by any suitable means, including hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

In some cases, rather than actually transmit signals, a device may provide such signals to another device for transmission. For example, a processor may provide signals via an interface (e.g., via a bus) to an RF front end for transmission. Similarly, rather than actually receive signals, a device may obtain such signals from another device for transmission. For example, a processor may obtain signals via an interface (e.g., via a bus) from an RF front end.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for testing communications between wireless devices, comprising:
obtaining test signals transmitted from at least one first device;
altering the test signals to simulate varying conditions of one or more wireless channels between the at least one first device and at least one second device;
providing the altered test signals to the at least one second device; and
obtaining feedback regarding reception of the altered test signals received at the at least one second device.

2. The method of claim 1, wherein altering the test signals comprises:
controlling one or more variable attenuators to vary attenuation of at least some frequencies of the test signals to simulate varying distances between the at least one first and second devices.

3. The method of claim 1, further comprising:
recording data rate as a function of attenuation for the test signals, based on the feedback.

4. The method of claim 1, wherein altering the test signals comprises:
controlling a plurality of variable attenuators to delay test signals routed through at least one of the variable attenuators to simulate multipath effects of transmissions between the at least one first device and the at least one second device.

5. The method of claim 1, wherein altering the test signals comprises:
controlling a plurality of variable attenuators to increase amplitude of at least some frequencies of the one or more wireless channels to simulate interference caused by one or more other channels.

6. The method of claim 1, wherein at least one of the obtained or providing is performed via one or more antennas.

7. The method of claim 1, wherein altering the test signals comprises:
controlling one or more variable attenuators to vary attenuation of certain frequencies of the test signals to simulate frequency selective fading.

8. The method of claim 1, comprising testing beamforming by at least one of:
selectively activating antennas of an array of transmit antennas at the first device; or
selectively activating antennas of an array of receive antennas at the second device.

9. An apparatus for testing communications between wireless devices, comprising:
a first interface configured to obtain test signals transmitted from at least one first device;
at least one controller configured to alter the test signals to simulate varying conditions of one or more wireless channels between the at least one first device and at least one second device;
a second interface configured to provide the altered test signals to the at least one second device to receive test signals transmitted from the at least one first device; and
a third interface configured to provide feedback to the at least one controller regarding reception of the altered test signals received at the at least one second device.

10. The apparatus of claim 9, wherein the at least one controller is configured to alter the test signals by:
controlling one or more variable attenuators to vary attenuation of at least some frequencies of the test signals to simulate varying distances between the at least one first and second devices.

11. The apparatus of claim 9, wherein the at least one controller is further configured to record data rate as a function of attenuation for the test signals, based on the feedback.

12. The apparatus of claim 9, wherein the at least one controller is configured to alter the test signals by:
controlling a plurality of variable attenuators to delay test signals routed through at least one of the variable attenuators to simulate multipath effects of transmissions between the at least one first device and at least one second device.

13. The apparatus of claim 9, wherein the at least one controller is configured to alter the test signals by:
controlling a plurality of variable attenuators to increase amplitude of at least some frequencies of one or more channels to simulate interference caused by one or more other channels.

14. The apparatus of claim 9, wherein at least one of the first or second interfaces comprises one or more antennas.

15. The apparatus of claim 9, wherein the at least one controller is configured to alter the test signals by:
controlling one or more variable attenuators to vary attenuation of certain frequencies of the test signals to simulate frequency selective fading.

16. The apparatus of claim 9, wherein the at least one controller is further configured to test beamforming by at least one of:
selectively activating antennas of an array of transmit antennas at the first device; or selectively activating antennas of an array of receive antennas at the second device.

17. An apparatus for testing communications between wireless devices, comprising:
a first interface configured to obtain test signals provided by at least one first device;
one or more variable attenuators configured to receive the test signals as input and configured to alter the test signals based on control signals; and
a second interface configured to provide the altered test signals to at least one second device.

18. The apparatus of claim 17, wherein at least one of the first interface or second interface comprises:
at least one antenna; and
an antenna-to-waveguide adapter coupled to the one or more variable attenuators.

19. The apparatus of claim 18, wherein the at least one antenna comprises at least one horn antenna.

20. The apparatus of claim 17, wherein at least one of the first interface or second interface comprises an antenna socket configured to accept insertion and removal of an antenna array of at least one of the first device or second device.
